(19) United States
(12) Patent Application Publication
(10) Pub. No.: US 2016/0047527 A1
(43) Pub. Date: Feb. 18, 2016

(54) Light Emitting Diode Lighting

(71) Applicant: Generpower (Shanghai) Co., Ltd., Shanghai (CN)

(72) Inventor: Shundong LIU, Shanghai (CN)

(21) Appl. No.: 14/730,013

(22) Filed: Jun. 3, 2015

(30) Foreign Application Priority Data
Aug. 12, 2014 (CN) 201420453441.2

(51) Int. Cl. F21V 7/00; F21K 99/00; F21V 29/70

(52) U.S. Cl. CPC F21V 7/0025; F21V 29/70; F21V 7/0066; F21K 9/50; F21Y 2101/02

(57) ABSTRACT

A LED lighting includes a lighting housing, a transmitting mask, a heat dissipating substrate, an aluminum substrate, a set of reflectors and a LED light source. The aluminum substrate is disposed on the heat dissipation substrate, and the LED light source is mounted on the surface of the aluminum substrate. The set of reflectors includes at least two independent reflectors which includes a bending portion and a reflecting portion, and the bending portion is connected the heat dissipating substrate and the surface of the reflecting portion is a reflecting surface. At least a portion LED light source is emitted to the reflecting portion and is emitted from the transmitting mask after the emitting light is reflected by the reflecting surface. The LED lighting is capable of the light evenly distribution for the required irradiating region and the LED lighting structure is simply to save the electric energy.

### FIELD OF THE INVENTION

The present invention relates to an illumination lighting, and in particular to a light emitting diode (LED) lighting.

### BACKGROUND OF THE INVENTION

The conventional illumination light is a high pressure sodium (SON) lamp or a metal halide lamp, and the life of the lamps above is about 8000 hrs. The life of LED lamp is more than about 30000 hrs and the LED lamp did not include the metallic mercury. With the development of the semiconductor technology, the performance of the LED lamp is improved continuously.

However, the present LED lamp has some drawbacks, such as the emitting angle of the LED light source is smaller and the irradiating region is too concentrated. In the case of generating the same luminous flux, the brightness of the required irradiating region is insufficient and uneven to result in the close is brightness but the distance is dark, the luminance of the closed region is higher than the luminance standard, or the luminance of the distance region is not reached the luminance standard. Because the irradiating distribution is uneven, in order to the luminance of the dark region is reached standard, the higher power and higher luminous flux of the light source is to be designed for meeting the luminance requirement of the dark region so as to result in the waste of the electric energy.

### SUMMARY OF THE INVENTION

The objective of the present invention is to overcome the drawback of the present technology and the present invention provides a light emitting diode (LED) lighting to improve the uneven distribution of required light irradiated region.

In order to achieve the objective above, the present invention is realized by the following technical solutions.

A light emitting diode (LED) lighting, includes a lighting housing, a transmitting mask, a heat dissipating substrate, an aluminum substrate, a set of reflectors and a LED light source. The aluminum substrate is disposed on the heat dissipation substrate, and the LED light source is mounted on the surface of the aluminum substrate. The set of reflectors includes at least two independent reflectors, each independent reflector includes a bending portion and a reflecting portion, in which the bending portion is connected the heat dissipating substrate and the surface of the reflecting portion is a reflecting surface. At least a portion LED light source is emitted to illuminate directly to the reflecting portion of each independent reflector and is emitted from the transmitting mask after the emitting light is reflected by the reflecting surface of the reflecting portion.

As a further refinement of the invention, the independent reflector of the present invention is made of the metal or metal alloy.

As a further refinement of the invention, the set of reflectors includes four independent reflectors.

As a further refinement of the invention, the same amount of the aluminum substrates and the independent reflectors.

As a further refinement of the invention, the same amount of LED light sources is mounted on each aluminum substrate.

As a further refinement of the invention, the reflecting surface is a curved surface which is concaved toward the center of the light emitting diode (LED) lighting.

As a further refinement of the invention, the reflecting surface is a plane surface.

Accordingly, the light emitting diode (LED) lighting of the present invention is capable of the light evenly distribution for the required irradiating region and the light emitting diode (LED) lighting structure is simply so as to the electric energy can be saved.

### BRIEF DESCRIPTION OF THE DRAWINGS

FIG. 1 is a schematic of a lighting of the first embodiment in accordance with the present invention.

FIG. 2 is an inner schematic of a lighting of the first embodiment in accordance with the present invention.

FIG. 3 is another inner schematic of a lighting of the second embodiment in accordance with the present invention.

### DETAILED DESCRIPTION OF THE PREFERRED EMBODIMENT

With reference to the drawing to illustrate the present invention.

### First Embodiment

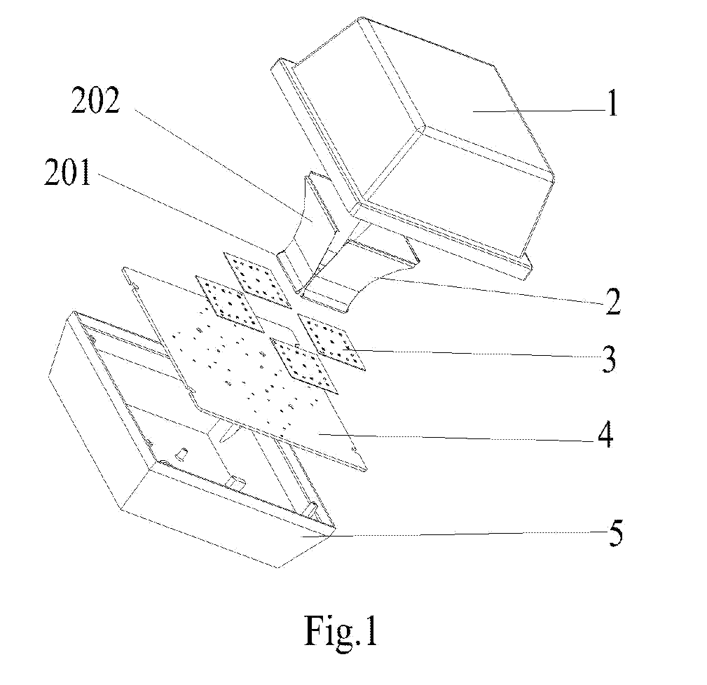

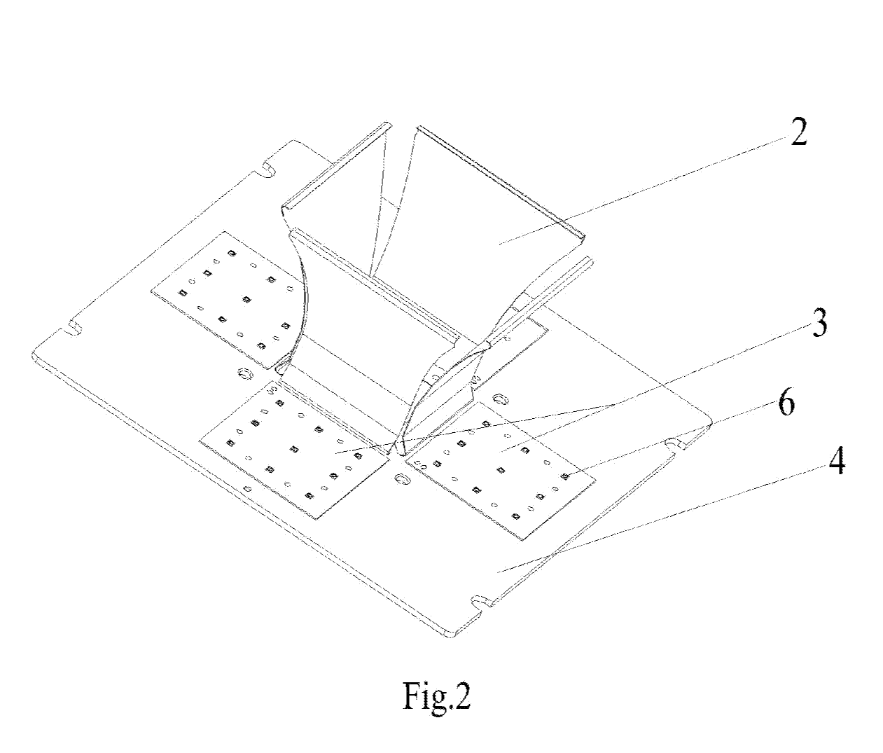

a light emitting diode (LED) lighting is shown in FIG. 1 and FIG. 2, the LED lighting includes a lighting housing 5, a transmitting mask 1, a heat dissipating substrate 4, an aluminum substrate 3, an independent reflector 2 and a LED light source 6.

The aluminum substrate 3 is disposed on the heat dissipating substrate 4, the LED light source 6 is mounted on the surface of the aluminum substrate 3, the set of reflectors includes four independent reflectors 2, and each independent reflector 4 having a bending portion 201 and a reflecting portion 202.

The bending portion 201 of each independent reflector 2 is connected the heat dissipating substrate 4 and the surface of the reflecting portion 202 is a reflecting surface.

Four aluminum substrates 3 are mounted inside the LED lighting, the same amount of the alumimim substrate 3 and the independent reflector 2. The same amount of the LED light source 6 are mounted on each aluminum substrate 3 respectively. The reflecting portion 202 of the independent reflector 2 is a curved surface which is concaved toward the center of the LED lighting. At least a portion LED light source 6 is emitted to illuminate directly to the reflecting portion 202 of each independent reflector 2 and is emitted from the transmitting mask 1 after the emitting light is reflected by the reflecting surface of the refection portion 202.

### Second Embodiment

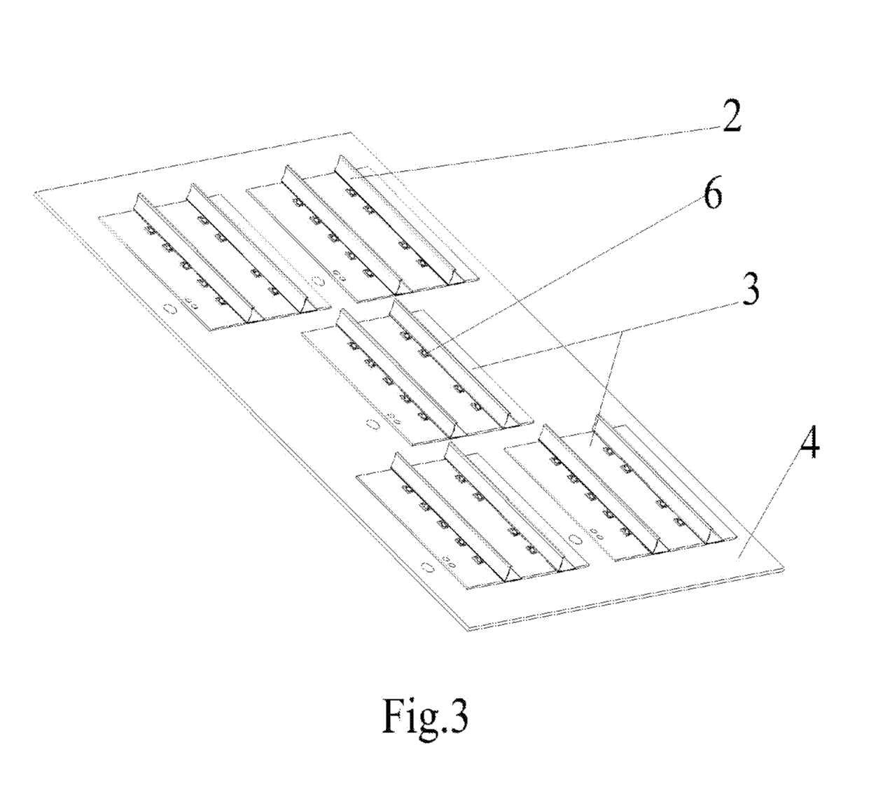

aLED lighting as shown in FIG. 3. The different between the second embodiment and the first embodiment is that the set of reflectors includes ten independent reflectors 2, five aluminum substrates 3 are disposed inside the LED lighting, and the amount of the aluminum substrate 3 is twice the independent reflector 2. The reflecting surface of each independent reflectors 2 is a plane surface. At least a portion I ED light source 6 is emitted to illuminate directly to the reflecting portion 202 of each independent reflector 2 and is emitted from the transmitting mask 1 after the emitting light is reflected by the reflecting surface of the refection portion 202.

Although the present invention has been described with reference to the preferred embodiment thereof, it is apparent to those skilled in the art that a variety of modifications and changes may be made without departing from the scope of the present invention which is intended to be defined by the appended claims.

What is claimed is

1. A light emitting diode lighting including a lighting housing, a transmitting mask, a heat dissipating substrate, an aluminum substrate, a set of reflectors, and a LED light source, the aluminum substrate is disposed on the heat dissipating substrate, and the LED light source is mounted on a surface of the aluminum substrate, the characteristic in that:
the set of reflectors having at least two independent reflectors, and each independent reflector having a bending portion and a reflecting portion, and the bending portion of each the independent reflectors connected the heat dissipating substrate, a surface of the reflecting portion is a reflecting surface, and at least a portion LED light source is illuminated directly to the reflecting portion of each independent reflector and is emitted from the transmitting mask after reflected by the reflecting surface.

2. The light emitting diode lighting according to claim 1, wherein the independent reflector is made of metal of metal alloy.

3. The light emitting diode lighting according to claim 1, wherein the set of reflectors include four independent reflectors.

4. The light emitting diode lighting according to claim 3, wherein the same amount of LED light sources are mounted on each aluminum substrate.

5. The light emitting diode lighting according to claim 4, wherein the same amount of LED light sources are mounted on each aluminum substrate.

6. The light emitting diode lighting according to claim 1, wherein the reflecting surface is a curved surface which is concaved toward the center of the light emitting diode lighting.

7. The light emitting diode lighting according to claim 1, wherein the reflecting surface is a plane surface.
